(19) United States
(12) Patent Application Publication
(10) Pub. No.: US 2003/0091491 A1
(43) Pub. Date: May 15, 2003

(54) Method for preparing phosphorus pentoxide powder with enhanced fluidity

(76) Inventor: Vincent Magne, Montvilliers (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/089,689

(22) PCT Filed: Aug. 2, 2001
(86) PCT No.: PCT/FR01/02527

(30) Foreign Application Priority Data
Aug. 2, 2000 (FR) 00/10348

(51) Int. Cl. C01B 25/12

(52) U.S. Cl. 423/304

(57) ABSTRACT

The invention concerns a method for preparing phosphorus pentoxide powder having enhanced fluidity, said method consisting in subjecting said phosphorus pentoxide powder to mechanical stirring at room temperature.

The present invention relates to a process for the preparation of phosphorus pentoxide (hexagonal variety), hereinafter P₂O₅, powder having improved flowability.

P₂O₅ is obtained industrially by combustion of white phosphorus in a stream of dry air in large excess. The reaction is exothermic and causes the temperature to rise to approximately 1 300° C. The combustion gases which result therefrom, consisting of a mixture of air depletes in O₂ and of gaseous P₂O₅, are conveyed to a condenser (desublimator), where P₂O₅ crystallizes in the powder form. Subsequently, the P₂O₅ powder obtained is generally sieved and then packaged in kegs or in containers.

P₂O₅ is an important industrial product. It is used in particular as intermediate reactant in the preparation of numerous phosphoric esters, used in particular in the agrochemical or pharmaceutical fields. These phosphoric esters are generally obtained by reacting solid P₂O₅ with an alcohol (generally in the liquid form or in solution). These reactions employ two different stages and require the presence of an efficient mixing method and a suitable means for introducing the P₂O₅ powder, in order to adhere to the stoichiometry and the kinetics of the reactions and to avoid excessively abrupt evolutions of heat when the P₂O₅ powder is introduced.

It is therefore necessary to have a P₂O₅ powder which has good processing properties, good transportation properties and good properties of dispersion in a reaction medium, in particular good flowability (or flow).

The term “flowability” denotes here the ability which a powder possesses to flow in a stable, uniform and even fashion in the form of individual particles through a narrow or wider orifice.

Numerous tests make it possible to determine the flowability of powders.

The “tamping” test is generally regarded as being the most appropriate for the evaluation of the flowability of P₂O₅ powders.

This test consists in measuring the ability of a powder to tamp down under the action of small impacts produced by a standardized rod. The measurement consists in estimating the difference between the initial volume and the volume occupied after 500 blows. The more a powder tamps down, the poorer its flowability.

On the basis of this test, three indices can be determined:

the aerated apparent density dₐ,

the tamped apparent density dₜ, and

the Hausner ratio Hr, which is equal to the dₜ/dₐ ratio.

When Hr decreases, the flowability of the powder improves as the density dₐ approaches the density dₜ.

In other words, the spaces between particles are more difficult to fill in with other smaller particles. The accumulation of these fines between the particles of various size leads to an increase in the interparticular forces, thus impeding the overall flow of the powder. The Hr ratio is therefore revealing of the arrangement of the particles with regard to one another. Thus, a P₂O₅ powder exhibiting an Hr ranging from 1 to 1.25 exhibits few processing problems. The density dₐ is close to the density dₜ.

The tamped apparent density dₜ alone is certainly not an index of flowability; however, its determination complements the knowledge of Hr insofar as, for a powder with a given particle size, if the density dₜ is high, then the gravitational forces become greater than the interparticular forces, resulting in natural flow being promoted. For the same Hr, when dₜ decreases, flow is promoted. Hr is a nondimensional parameter; dₜ makes it possible to compare powders with one another.

The aerated (or true) apparent density dₐ cannot be used either as index of flowability but is used in techniques for the transportation and packaging of P₂O₅ powders.

The Applicant Company has found that, in the industrial preparation of P₂O₅ as mentioned above, it obtained, in an entirely random fashion, batches of P₂O₅ powder having poor flowability (high Hr) prohibiting it from being subsequently used, in particular from being used as intermediate reactant for the synthesis of phosphoric esters.

Patent EP 189 766 B1 discloses a process which makes it possible in particular to improve the flowability of P₂O₅ powders. This process consists in heating P₂O₅ (hexagonal variety) powders at temperatures ranging from 200° C. to 390° C. for 0.5 to 8 hours in a closed and optionally stirred reactor.

This process makes it possible to obtain a substantial improvement in the flowability of P₂O₅ powders, an improvement obtained, however, by using high temperatures and lengthy “annealing” times, which conditions put a considerable strain on the productive capacity of an industrial process. In addition, this process requires an expensive investment in equipment.

In addition, this heat or annealing treatment lowers the “reactivity” of the P₂O₅ (hexagonal variety) powder. This reactivity is evaluated by a simple test which consists in reacting a solution of P₂O₅ in an aromatic solvent, such as ortho-dichlorobenzene, with a phenol.

The measurement is then made of the evolution of heat produced by the reaction over a predetermined period of time.

The reactivity of the P₂O₅ is therefore quantified in ° C./min.

This reactivity, specific to hexagonal P₂O₅, is a characteristic increasingly required by many users of P₂O₅, who wish to have a P₂O₅ powder having good flowability and high reactivity.

The Applicant Company has found that it is possible to obtain a P₂O₅ (hexagonal variety) powder which has improved flowability, which has good dispersion and which retains high reactivity, by subjecting the P₂O₅ powder to a mechanical treatment by the dry route at ambient temperature.

The subject-matter of the invention is therefore a process for the preparation of a phosphorus pentoxide (hexagonal variety) powder with improved flowability, characterized in that said powder is subjected to mechanical stirring by the dry route at ambient temperature under a dry gas atmosphere for a period of time ranging from 5 minutes to 30 minutes and preferably of between 10 and 20 minutes.

The P₂O₅ powder subjected to such a mechanical treatment can have various origins.

It can originate from a P₂O₅ powder storage area. It can also originate directly from a process for the manufacture of P₂O₅, which consists in continuously introducing liquid white phosphorus and dry air in excess, with respect to the stoichiometry of the reaction:

P₄+25[0.2O₂+0.8N₂]→P₄O₁₀(2P₂O₅)+20N₂

into a combustion region, in cooling the combustion gases exiting from this region of the in condenser (or desublimators), in recovering the P₂O₅ powder obtained in said condensers and in conveying it by means of a screw conveyor to a mechanical treatment region according to the present invention.

In this case, the P₂O₅ powder obtained, exiting from the screw conveyor, can be at a temperature slightly greater than ambient temperature.

According to the present invention, the term “ambient temperature” denotes a temperature ranging from 15° C. to 30° C. and preferably of between 20 and 25° C. This temperature is the temperature of the mechanical treatment and means that said treatment is carried out in a device which is neither heated nor cooled.

According to the present invention, the mechanical treatment of the P₂O₅ powder is carried out by the dry route. This means that no solvent is used during this treatment.

The treatment is carried out under an atmosphere of a dry gas, such as air. The use of an inert gas is not necessary.

According to the present invention, the mechanical stirring operation can be carried out in any device allowing efficient deagglomeration of powders.

Use will preferably be made of “plowshare” mixers which exhibit a stirring rate ranging from 100 rev/min to 350 rev/min and preferably ranging from 150 rev/min to 300 rev/min and which make it possible to obtain a Froude number Fr, representing the ratio of the centrifugal forces to the gravitational forces, which can range up to 5.

The charge of the powder subjected to stirring in the mixer is defined by the power per mass Pm, according to the relationship:

Pm=kW/kg of product to be treated (kW.kg⁻¹)

The stirring time is short; generally 10 to 15 minutes is sufficient to produce a powder of good flowability, that is to say a powder exhibiting an Hr≦1.25.

According to the present invention, the stirred P₂O₅ powder is transferred to a storage area before it is packaged.

The process according to the present invention exhibits the advantage of resulting in a P₂O₅ powder which has good processing properties, in particular good dispersion, and good flowability (Hr≦1.25), this being achieved without addition of any anticaking agent, and which also exhibits a reactivity at least equal to, indeed even greater than, that measured before the mechanical treatment.

The following examples illustrate the invention.

### EXAMPLES

Production of the P₂O₅ powder:

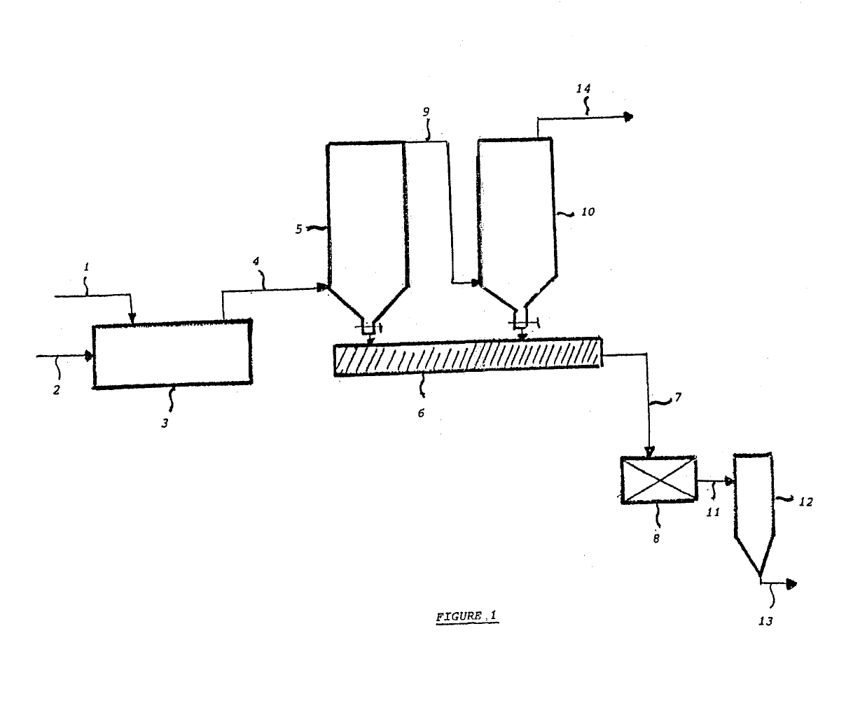

The P₂O₅ powder was obtained in a plant as represented diagrammatically in FIG. 1, according to a process which consists in continuously introducing liquid white phosphorus via the pipe (1) and dry air via the pipe (2) into a combustion region (3) composed of a cooled cylindrical chamber.

The combustion gases exiting from the combustion region at a temperature of between 600° C. and 650° C. are conveyed via the pipe (4) to a cylindrically-shaped condenser (5) terminated by a frustoconical part, cooled by a film of water with a regulated flow rate, in which the solid P₂O₅ particles are formed in the cooled gases and grow until precipitating within the gas mixture to form a finely divided solid mass which falls to the bottom of said condenser into the hopper and which is subsequently conveyed by means of a screw conveyor belt (6) and a pipe (7) to a mixer (8) where it will be subjected to the mechanical treatment according to the invention.

The gases exiting from the condenser (5) are conveyed via the pipe (9) to a second condenser (10), identical to the condenser (5), from which P₂O₅ powder is also recovered, the powder falling into the same screw conveyor (6).

The gases exiting from the condenser (10), composed of depleted air, are discharged into the atmosphere via the pipe (14).

The treated powder is conveyed via the pipe (11) to a storage area (2) from which packaging is carried out via (13).

P₂O₅ powder is withdrawn before and after the mixer (8), via a device not represented in FIG. 1, in order to determine its flowability and reactivity characteristics.

The operating conditions for the manufacture of the P₂O₅ powders are listed below in table 1.

TABLE 1

Flow rates

| | Liquid white phosphorus | |
|---|---|---|
| Conditions | (kg/h) | Dry air (Sm³/h) |
| A | 180 | 1100 |
| B | 100 | 700 |

Mechanical Treatment of the P₂O₅ Powders Obtained According to Conditions A and B:

Device Used:

Plowshare mixer of MXC 0150 type with a capacity of 150 liters, sold by Gericke

Mechanical Treatment Conditions:

temperature: approximately 25° C.

stirring rate (rev/min): 300

charge (kg): 80

power per mass Pm (W.kg⁻¹): 56

stirring time (min): 15

gas used: dry air.

Results of the Treatment:

The characteristics:

aerated density dₐ,

tamped density dₜ,

Hausner ratio Hr=dₜ/dₐ, and the reactivity of the P₂O₅ powders treated according to the invention and of the untreated P₂O₅ powders are listed in table 2. These characteristics were determined by using the tests below.

Tamping Test:

Principle:

The Hr ratio measures the ability of the particles to tamp down under the action of small standardized impacts. A predetermined amount of powder is poured into a measuring cylinder. The measurement then consists in recording the initial volume of the sample and then the volume occupied by the powder after a chosen number of impacts.

The Hr ratio is determined with a volumeter.

Equipment:

glove box under dry air,

volumeter (device used to tamp down the powder in accordance with Standards ISO R787 and ASTM B522 70),

250 ml round-based measuring cylinders,

balance,

stainless steel funnel,

stainless steel sieve with a diameter of 2 mm,

stainless steel scoop,

spatula,

which are washed and dried in an oven at 80° C.

Procedure:

1.The powder to be analyzed is sieved, so as to remove the various cases of tamping due to prior handling operations.

2. 100 g, plus or minus 2 g, are placed in a measuring cylinder using the funnel. To allow the powder to flow, a stainless steel plate is regularly tapped against the funnel, care being taken not to touch the edge of the measuring cylinder. Care also has to be taken not to tamp down the powder and not to deposit too much of it along the glass of the measuring cylinder. The mass and the volume are recorded.

3. The measuring cylinder is placed on the volumeter and 500 blows are applied by it. This operation is repeated three times.

Calculation:

Aerated density: Mass of powder introduced into the measuring cylinder/initial volume (before tamping)

Tamped density: Mass of powder introduced into the measuring cylinder/final volume (after tamping)

Hausner ratio: Hr: Tamped density/Aerated density

Interpretation of the Results:

Hr≦1.25: very good ability to flow,

1.26≦Hr≦1.30: good ability to flow,

1.31≦Hr≦1.4: flow difficult,

Hr>1.4: free flow virtually impossible.

Reactivity Test:

Principle:

P₂O₅ is reacted with a phenol. The change in temperature of the mixture as a function of time is recorded and the reactivity is determined by the, measurement of the slope of the tangent to the point of inflection of the curve: temperature=f(time). Temperature of the beginning of the test: 25° C. Introduction of the phenol all at once.

Reactants:

xylenol (2,4-dimethylphenol)

ortho-dichlorobenzene

Equipment:

1 direct-current stirrer with a speed counter which is equipped with an anchor stirrer,

1 temperature-recording device equipped with an iron/constantin thermocouple probe,

1 bath adjustable to 25° C.,

1 laboratory balance,

1 Dewar flask.

Procedure:

the bottles of reactants are placed in the heating bath, adjusted to 30° C.,

the Dewar flask is washed with hot water and is dried with acetone,

20 g of P₂O₅ are weighed out exactly in the clean and dry Dewar flask,

the Dewar flask is placed on a rubber ring and the stirrer is adjusted so as to leave the least possible space between the stirrer and the wall of the flask (approximately 1 mm),

it is confirmed that the anchor of the stirrer rotates freely without rubbing against the walls of the flask,

44 cm³ of ortho-dichlorobenzene are measured out using a measuring cylinder,

the ortho-dichlorobenzene is poured into the flask while rinsing the walls thereof,

the stirring rate is adjusted to 300 rev/min,

56.5 g of xylenol are weighed out in a beaker,

the thermocouple is adjusted (the temperature must be 25° C.),

the xylenol is poured into the flask and the recorder, calibrated beforehand, is started: rate of progression of the paper 6 cm/min,

the recording is halted as soon as the temperature reaches 80° C.

Results:

The tangent to the point of inflection of the curve of temperature as a function of time is plotted. Its slope determines the reactivity of the P₂O₅ powder in ° C./min.

TABLE 2

| | Conditions | Mechanical | | | | |
|---|---|---|---|---|---|---|
| | for the | treatment | Characteristics of the powder | | | |
| | manufacture | according | Density (kg/m³) | | Hr | |
| | of the P₂O₅ | to the | Aerated | Tamped | (dₜ/ | Reactivity |
| Test | powder | invention | (dₐ) | (dₜ) | dₐ) | (° C./min) |
| 1 | A | no | 866 | 1118 | 1.29 | 4 |
| | A | yes | 1041 | 1272 | 1.22 | 8.5 |
| 2 | B | no | 629 | 851 | 1.35 | 6 |
| | B | yes | 877 | 1087 | 1.24 | 12.5 |

1. A process for the preparation of a phosphorus pentoxide (hexagonal variety) powder with improved flowability, characterized in that said phosphorus pentoxide powder is subjected to mechanical stirring by the dry route at ambient temperature under a dry gas atmosphere for a period of time ranging from 5 minutes to 30 minutes.

2. The process as claimed in claim 1, characterized in that the mechanical stirring time is between 10 and 20 minutes.

3. The process as claimed in either of claims 1 and 2, characterized in that the stirring rate of the device used for carrying out the process ranges from 100 rev/min to 350 rev/min.

4. The process as claimed in claim 3, characterized in that the stirring rate is between 150 rev/min and 300 rev/min.

5. The process as claimed in any one of claims 1 to 4, characterized in that it is carried out at a temperature ranging from 15 to 30° C.

6. A phosphorus pentoxide (hexagonal variety) powder obtained as,claimed in one of claims 1 to 5, exhibiting a Hausner ratio Hr, defined as being the ratio of the tamped apparent density dₜ to the aerated apparent density dₐ, of equal to or less than 1.25.
